(19) United States
(12) Patent Application Publication
(10) Pub. No.: US 2026/0284774 A1
(43) Pub. Date: Sep. 24, 2026

(54) Ultrasonic Assisted Additive Friction Stir Deposition

(71) Applicant: University of Kentucky Research Foundation, Lexington, KY (US)

(72) Inventors: James Robert Caudill, Lexington, KY (US); Manpreet Singh, Lexington, KY (US); Ibrahim S. Jawahir, Lexington, KY (US)

(21) Appl. No.: 19/570,501

(22) Filed: Mar. 18, 2026

Related U.S. Application Data
(60) Provisional application No. 63/773,942, filed on Mar. 18, 2025.

(51) Int. Cl. B23K 20/12; B23K 20/10; B33Y 10/00; B33Y 30/00

(52) U.S. Cl. CPC B23K 20/1215; B23K 20/10; B23K 20/1245; B33Y 10/00; B33Y 30/00

(57) ABSTRACT

An apparatus for ultrasonic assisted additive friction stir deposition includes a tool body, including a print head, and a drive motor, adapted for rotating the tool body and the print head. The apparatus further includes a feedstock feeding mechanism, adapted for feeding a feedstock to the print head, and an ultrasonic horn assembly, adapted for superimposing ultrasonic vibrations onto the tool body and the print head. Still further, the apparatus includes a substate upon which layer on layer of feedstock material is deposited. Frictional heat, generated by stirring action of the rotating print head, and ultrasonic energy, generated by the ultrasonic horn assembly, function together to provide more uniform temperature distribution and enhance the quality of the feedstock material deposition.

### RELATED APPLICATIONS

This application claims the benefit of U.S. Provisional Patent Application Ser. No. 63/773,942, filed March 18, 2025, the disclosure of which is incorporated herein by reference.

### STATEMENT REGARDING FEDERALLY SPONSORED RESEARCH OR DEVELOPMENT

This invention was made with government support under contract number W911NF-21-2-0075 awarded by the Army Research Office. The government has certain rights in the invention.

### TECHNICAL FIELD

This document relates to an enhanced additive friction stir deposition (AFSD) process, wherein ultrasonic excitation is integrated into the system to optimize material flow, reduce axial forces, and facilitate deposition of high-strength and high-melting-temperature materials. This is achieved by utilizing a specially designed sonotrode assembly that transmits ultrasonic energy efficiently to the AFSD tool.

### BACKGROUND

The standard additive friction stir deposition process relies on frictional heat generated due to extrusion and stirring action of the rotating tool. However, when dealing with high-strength materials or materials with elevated melting points, the frictional heat alone is often insufficient for proper softening, necessitating excessively high axial forces to maintain deposition efficiency. This document introduces a novel ultrasonic-assisted additive friction stir deposition (UA-AFSD) apparatus and process, where ultrasonic vibrations are superimposed onto the AFSD tool using a sonotrode-based ultrasonic transducer assembly. The introduction of ultrasonic energy into the AFSD system enhances material flow, reduces axial forces, and allows for the effective deposition of challenging materials.

### SUMMARY

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term ”consisting of”.

As used herein, “substantially” is meant to permit deviations from the descriptive term that don’t negatively impact the intended purpose. Descriptive terms are implicitly understood to be modified by the word substantially, even if the term is not explicitly modified by the word substantially.

As used herein, the singular forms “a,” “an” and “the” include plural referents unless the context clearly dictates otherwise.

As used herein, “about,” “approximate,” “at or about,” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

In accordance with the purposes and benefits set forth herein, a new and improved apparatus for ultrasonic assisted additive friction stir deposition, comprising, consisting of, or consisting essentially of:
(a) a tool body including a print head;
(b) a drive motor adapted for rotating the tool body and the print head;
(c) a feedstock feeding mechanism adapted for feeding a feedstock to the print head;
(d) a sonotrode-based ultrasonic horn assembly adapted for superimposing ultrasonic vibrations onto the tool body and the print head; and
(e) a substate upon which layer on layer of feedstock material is deposited whereby frictional heat, generated by stirring action of the rotating print head, and ultrasonic energy, generated by the ultrasonic horn assembly, function together to provide more uniform temperature distribution and enhance quality of feedstock material deposition.

In at least some of the many possible embodiments, the ultrasonic horn assembly includes a horn body connected to a sound transducer via an amplification/reduction booster. The horn body may include a tool body receiver, including a bushing adapted to transmit ultrasonic energy from the horn body to the tool body, the print head and the feedstock material being deposited. The tool body may extend through the bushing. In at least some embodiments, the bushing is cylindrical in shape and the horn body includes four spaced contact interfaces adapted for transmitting ultrasonic energy from the horn body, through the bushing, to the tool body. Each of the four spaced contact interfaces may extend along an arc of about 25-35 degrees. In one particularly useful embodiment, the four contact surfaces extend through an arc of about 29.48 degrees. In at least some embodiments, each of the four spaced contact interfaces are separated by an arc of about 55-65 degrees. In one particularly useful embodiment, the separation between contact surfaces extends through an arc of about 60.52 degrees.

The apparatus may also include the sound transducer operating at a frequency of between 19.7 and 20.3 kilohertz. The horn body may be made from grade 5 titanium alloy, Ti6A14V, using half-wavelength configuration whereby peak amplitude of ultrasonic waves occur at the tool receiver.

In accordance with an additional aspect, a method for ultrasonic assisted additive friction stir deposition, comprises, consists of or consists essentially of combining frictional heat, generated by stirring action of a rotating print head, and ultrasonic energy, generated by an ultrasonic horn assembly, to provide more uniform temperature distribution and enhance quality of feedstock material deposition.

In accordance with yet another aspect, a method for ultrasonic assisted additive friction stir deposition, comprises, consists of, or consists essentially of:
(a) feeding a feedstock material to a print head;
(b) rotating the print head to generate frictional energy;
(c) superimposing ultrasonic vibrations onto the print head; and
(d) depositing feedstock material at the print head.

The method may further include producing vibratory motion of the print head to induce localized heating due to interfacial friction between a substrate and a deposited layer of feedstock material. The method may further include elevating temperature of the feedstock material being deposited while reducing axial forces on the feedstock material.

The superimposing of the ultrasonic vibrations onto the print head may further include transmitting ultrasonic energy with a sound transducer and propagating ultrasonic vibrations through a horn to a tool body carrying the print head. The method may further include propagating ultrasonic vibrations from the horn, through spaced contact interfaces to a bushing encircling the tool body.

The method may further include providing peak amplitude of ultrasonic waves at the bushing. The method may further include operating the sound transducer at a frequency between 19.7 and 20.3 kilohertz. In at least some embodiments, the method may further include using a booster for amplification of sound amplitude by 1.5 times. The method may include propagating the ultrasonic vibrations from the sound transducer to the print head through a horn encircling a tool body carrying the print head.

Other systems, methods, features, and advantages of the present disclosure will be or become apparent to one with skill in the art upon examination of the following drawing and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWING FIGURES

Many aspects of the present disclosure can be better understood with reference to the following drawing figure. The components in the drawing figure are not necessarily to scale, emphasis instead being placed upon clearly illustrating the principles of the present disclosure.

FIG. 1 is a perspective view of the new and improved apparatus for ultrasonic assisted additive friction stir deposition.

FIG. 2 is a cross-sectional view illustrating the horn assembly including the bushing that makes contact with the tool body to superimpose sound vibrations from the transducer upon the tool body, the metal feedstock rod and the material undergoing plastic deformation.

FIGS. 3A-3C are respective perspective, side elevational, and top plan views of the horn body.

### DETAILED DESCRIPTION

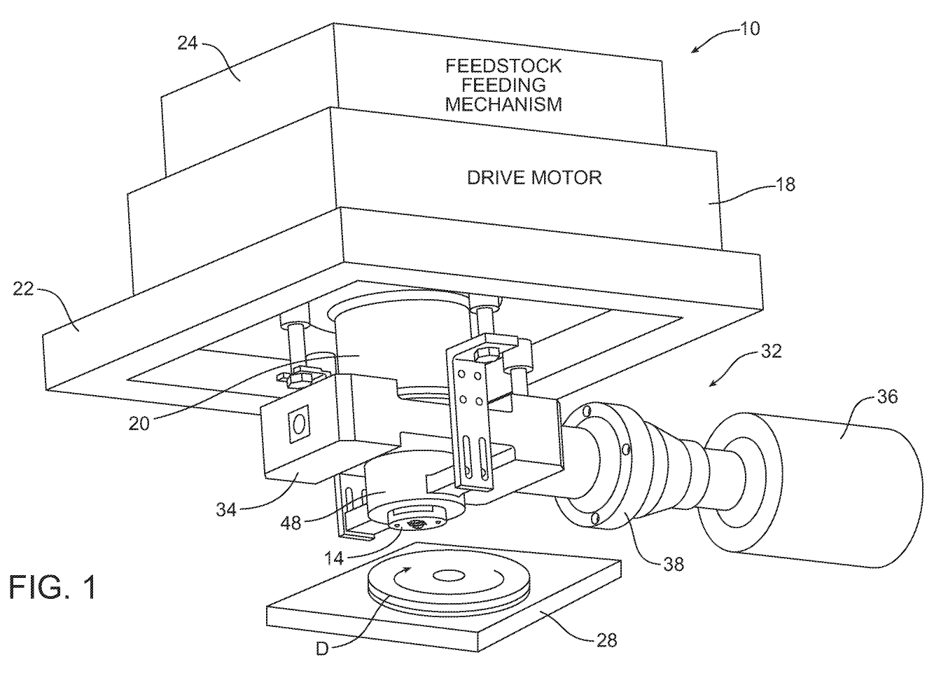

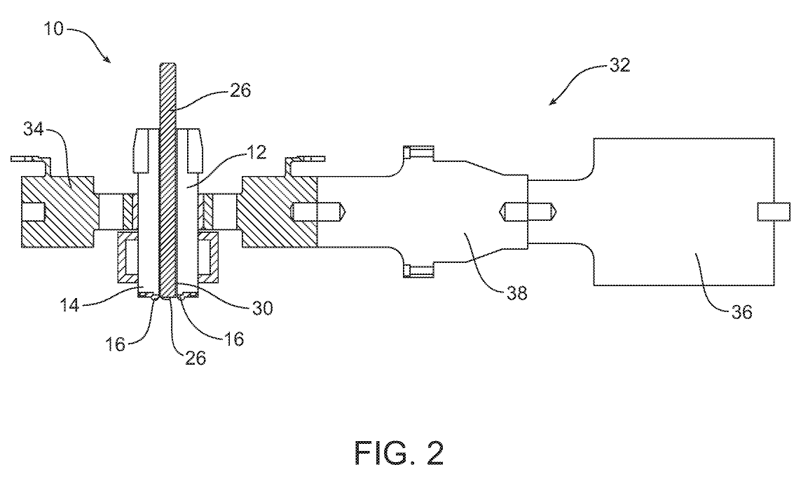

Reference is now made to FIGS. 1 and 2 which illustrate the new and improved apparatus 10 for ultrasonic assisted additive friction stir deposition. The apparatus includes a tool body 12 including a print head 14 having one or more protrusions 16. As is known in the art, the tool body 12 is connected to a drive motor 18 by a spindle 20. The drive motor 18, supported on the machine frame 22, is adapted for rotating the tool body 12 and the print head 14.

As also known in the art, a feedstock feeding mechanism 24 is adapted for feeding a feedstock rod 26 through the print head 14. The feedstock rod 26 comprises the material that is softened, undergoes plastic deformation and is deposited in layers D on an underlying substrate 28 by the rotating print head 14. In the illustrated embodiment, the feedstock rod 26 is fed through a central opening 30 in the tool body 12 and print head 14.

An ultrasonic horn assembly, generally designated by reference numeral 32, is adapted for superimposing ultrasonic vibrations onto the tool body 12, the print head 14, the feedstock rod 26, and the material being deposited. The frictional heat, generated by stirring action of the rotating print head 14, and ultrasonic energy, generated by the ultrasonic horn assembly 32, function together in a synergistic manner to provide more uniform temperature distribution and enhance quality of feedstock material deposition beyond that possible with simple additive friction stir deposition. This is a particularly advantageous result when printing with feedstock rods 26 comprised of high-strength materials and/or high-melting point materials. For purposes of this document, “high-strength materials” refers to materials having a yield strength of greater than 500 megapascal (MPa).

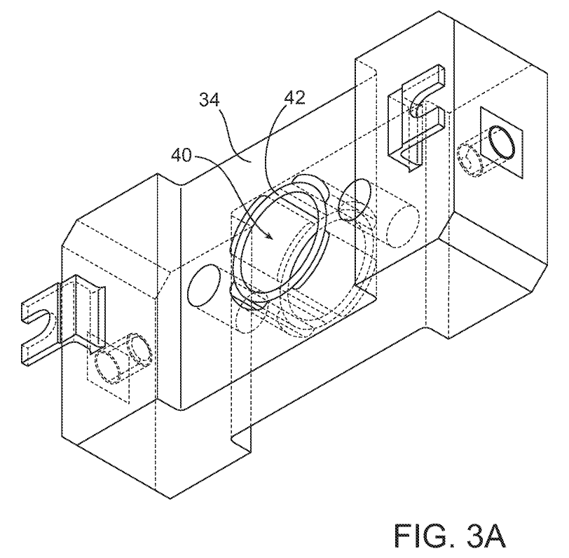

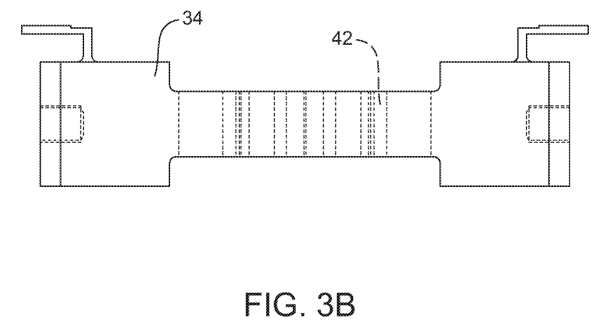

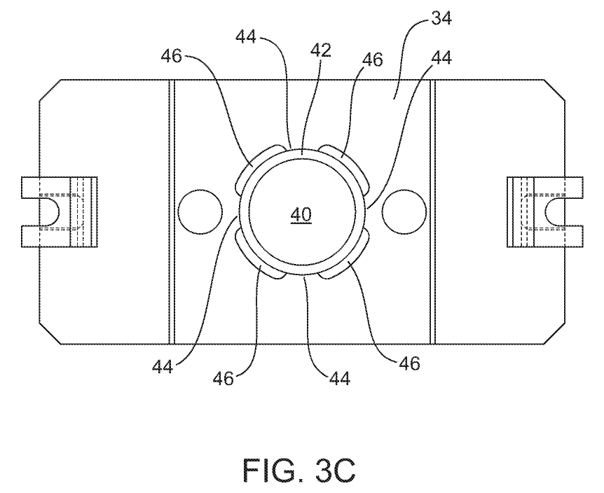

As shown in FIGS. 1 and 2, the ultrasonic horn assembly 32 includes a horn body 34 connected to a sound transducer 36 by means of an amplification/reduction booster 38. See also FIGS. 3A-3C. The efficiency of the ultrasonic energy transmission is determined by the sonotrode or horn body 34 geometry and material properties. The horn body 34 is designed to match the acoustic impedance of the tool body 12. This ensures efficient ultrasonic energy transfer and prevents unwanted reflection or dissipation. Toward this end, the horn body 34 undergoes an iterative design optimization process to achieve:
(a) resonant frequency alignment with the tool body 12;
(b) amplitude amplification at the targeted vibration mode; and
(c) efficient energy transmission without unnecessary damping.

The horn body 34 is preferably fabricated from a titanium alloy, such as Ti-6Al-4V, Such a material is chosen for its (a) high fatigue resistance, allowing prolonged ultrasonic excitation, (b) balanced acoustic impedance, ensuring efficient energy propagation, and (c) structural robustness, preventing deformation under high-frequency vibration.

As best illustrated in FIGS. 3A-3C, the horn body 34 includes a tool receiver 40, in the form of a central opening extending completely through the horn body. A cylindrical bushing 42 is held in the tool receiver 40. The bushing 42 is sized and shaped to receive the tool body 12. Further, the bushing 42 is adapted to transmit ultrasonic energy from the horn body 34 into the tool body 12 and from there into the print head 14, the feedstock rod 26, and the material undergoing plastic deformation and deposited in layers D on the substrate 28.

As should be appreciated, the ultrasonic horn assembly 32 is specifically designed to introduce ultrasonic vibrations into the additive friction stir deposition process, thereby supplementing conventional frictional heating with additional mechanical energy. This dual energy approach facilitates enhanced material plasticization, enabling deposition of materials that are otherwise challenging to process with standard additive stir deposition techniques.

Vibrational energy generated by the transducer 36 propagates to the horn body 34 through the booster 38 and then through the bushing 42 into the tool body 12. More specifically, as best shown in FIG. 3C, the horn body 34 includes four spaced contact interfaces 44 adapted for transmitting ultrasonic energy from the horn body into the bushing 42 and ultimately the tool body 12. Each of the four spaced contact interfaces 44 may extend through an arc of 25-35 degrees (an arc of about 29.48 degrees is shown). Further, each of the spaced contact interfaces are separated by a space or gap 46 extending through an arc of between 55-65 degrees (an arc of about 60.52 degrees is shown). Preferably, the horn body 34 is designed using a half-wavelength configuration, whereby peak amplitude of the ultrasonic waves occur at the tool receiver.

The ultrasonic horn assembly 32 is engineered for direct compatibility with the tool body 12 and is securely mounted around the tool body 12 without interfering in any manner with the deposition process. As illustrated in FIG. 1, there is still room for a state of the art cooling jacket 48 around the tool body 12. Spindle dynamics and material deposition mechanics are not altered, thereby ensuring operational stability.

Unlike conventional ultrasonic-assisted machining systems, that are designed for cutting operations, this ultrasound system is specifically optimized for continuous plastic deformation. The bushing 42 provides a stable and low-dissipation connection with the tool body 12. The interface design 44, 46 minimizes energy loss while ensuring consistent ultrasonic transmission.

During operation, ultrasonic frequency is optimized for resonant excitement at about 19.7-20.3 kilohertz (kHz). Vibration amplitude is adjustable based upon material/process requirements up to about 27 µm max. Power input is dependent upon material/tool but is optimized to avoid overheating. Coupling may be direct or indirect with minimal damping effects.

The superimposed vibratory motion of the tool body 12 induces localized heating due to interfacial friction with the substrate 28 and the layer of feedstock rod material being deposited. This elevates the temperatures, reducing required axial forces required for plastic deformation and improving material flow. Computational analysis has shown that the combined effect of frictional and ultrasonic heating results in a more uniform temperature distribution, optimizing deposition quality.

The apparatus 10 described above is useful in a method for ultrasonic assisted additive friction stir deposition. Such a method may be broadly described as comprising the combination of frictional heat, generated by stirring action of a rotating print head, and ultrasonic energy, generated by an ultrasonic horn assembly, to provide more uniform temperature distribution and enhance quality of feedstock material deposition.

More specifically, the method includes (a) feeding a feedstock material to a print head 14, (b) rotating the print head to generate frictional energy, (c) superimposing ultrasonic vibrations onto the print head, and (d) depositing feedstock material on a substrate 28 at the print head. The method may further include producing vibratory motion of the print head 14 to induce localized heating due to interfacial friction between the substrate and a deposited layer of feedstock material. Still further, the method may include elevating temperature of the feedstock material being deposited while reducing axial forces on the feedstock material.

The superimposing of ultrasonic vibrations onto the print head 14 may include transmitting ultrasonic energy with a sound transducer 36 and propagating ultrasonic vibrations through a horn body 34 to a tool body 12 carrying the print head 14. This may further include propagating ultrasonic vibrations from the horn body 34, through spaced contact interfaces 44 to a bushing 42, encircling the tool body 12. See FIG. 2.

The method may include providing peak amplitude of ultrasonic waves at the bushing 42 as well as operating the sound transducer 36 at a frequency between 19.7 and 20.3 kilohertz (i.e. nominal 20 kHz). The method may include the use of a booster 38 for amplification of sound amplitude by about 1.5 times. Still further, as illustrated, the method may include propagating the ultrasonic vibrations from the sound transducer 36 to the print head 14 through a horn body 34 and a bushing 42 encircling the tool body 12 carrying the print head.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

What is claimed:

1. An apparatus for ultrasonic assisted additive friction stir deposition, comprising:
a tool body including a print head;
a drive motor adapted for rotating the tool body and the print head;
a feedstock feeding mechanism adapted for feeding a feedstock to the print head;
an ultrasonic horn assembly adapted for superimposing ultrasonic vibrations onto the tool body and the print head; and
a substate upon which layer on layer of feedstock material is deposited whereby frictional heat, generated by stirring action of the rotating print head, and ultrasonic energy, generated by the ultrasonic horn assembly, function together to provide more uniform temperature distribution and enhance quality of feedstock material deposition.

2. The apparatus of claim 1, wherein the ultrasonic horn assembly includes a horn body connected to a sound transducer via an amplification/reduction booster.

3. The apparatus of claim 2, wherein the horn body includes a tool body receiver, including a bushing adapted to transmit ultrasonic energy from the horn body to the tool body, the print head and the feedstock material being deposited.

4. The apparatus of claim 3, wherein the tool body extends through the bushing.

5. The apparatus of claim 4, wherein the bushing is cylindrical in shape and the horn body includes four spaced contact interfaces adapted for transmitting ultrasonic energy from the horn body through the bushing to the tool body.

6. The apparatus of claim 5, each of the four spaced contact interfaces extends along an arc of about 29.48 degrees.

7. The apparatus of claim 6, wherein each of the four spaced contact surfaces are separated by an arc of about 60.52 degrees.

8. The apparatus of claim 7, further including a booster.

9. The apparatus of claim 1, further including operating the sound transducer at a frequency of between 19.7 and 20.3 kilohertz.

10. The apparatus of claim 1, wherein the horn body is made from grade 5 titanium alloy, Ti6A14V, using a half-wavelength configuration whereby peak amplitude of ultrasonic waves occur at the tool receiver.

11. A method for ultrasonic assisted additive friction stir deposition, comprising:
combining frictional heat, generated by stirring action of a rotating print head, and ultrasonic energy, generated by an ultrasonic horn assembly, to provide more uniform temperature distribution and enhance quality of feedstock material deposition.

12. A method for ultrasonic assisted additive friction stir deposition, comprising:
feeding a feedstock material to a print head;
rotating the print head to generate frictional energy;
superimposing ultrasonic vibrations onto the print head; and
depositing feedstock material on a substrate at the print head.

13. The method of claim 12, further including producing vibratory motion of the print head to induce localized heating due to interfacial friction between the substrate and a deposited layer of feedstock material.

14. The method of claim 12, further including elevating temperature of the feedstock material being deposited while reducing axial forces on the feedstock material.

15. The method of claim 12, wherein the superimposing of the ultrasonic vibrations onto the print head includes transmitting ultrasonic energy with a sound transducer and propagating ultrasonic vibrations through a horn to a tool body carrying the print head.

16. The method of claim 15, further including propagating ultrasonic vibrations from the horn, through spaced contact interfaces to a bushing encircling the tool body.

17. The method of claim 16, including providing peak amplitude of ultrasonic waves at the bushing.

18. The method of claim 17, including operating the sound transducer at a frequency between 19.7 and 20.3 kilohertz.

19. The method of claim 16, including the use of booster for amplification of sound amplitude by 1.5 times.

20. The method of claim 19, including propagating the ultrasonic vibrations from the sound transducer to the print head through a horn encircling a tool body carrying the print head.
